(19) United States
(12) Patent Application Publication
(10) Pub. No.: US 2024/0286690 A1
(43) Pub. Date: Aug. 29, 2024

(54) METHOD AND SYSTEM FOR DATA DRIVEN DOWNFORCE CONTROL

(71) Applicant: GM Global Technology Operations LLC, Detroit, MI (US)

(72) Inventors: Mohammad Pournazeri, Etobicoke (CA); Ehsan Asadi, Markham (CA); Naser Mehrabi, Richmond Hill (CA); SeyedAlireza Kasaiezadeh Mahabadi, Novi, MI (US)

(21) Appl. No.: 18/173,925

(22) Filed: Feb. 24, 2023

(51) Int. Cl. B62D 37/02; B62D 35/00

(52) U.S. Cl. CPC B62D 37/02; B62D 35/005; B62D 35/007

(57) ABSTRACT

A method for data driven downforce control of a vehicle includes receiving a first requested downforce at the front axle of a vehicle and a second requested downforce at the rear axle of the vehicle. The method further includes using a model-based control to determine a first position of the first aerodynamic body relative to the vehicle body and a second position of the second aerodynamic body relative to the vehicle body based on the first requested downforce and the second requested downforce. The model-based control is based on a predetermined aerodynamic map. The method includes commanding the first aerodynamic actuator to move the first aerodynamic body to the first position. The method includes commanding the second aerodynamic actuator to move the second aerodynamic body to the second position.

The present disclosure relates to methods and systems for data driven downforce control of a vehicle.

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Downforce refers to the vertical load created by a vehicle's aerodynamic parts during motion. Some vehicles include actuators for controlling the downforce.

### SUMMARY

The present disclosure describes a method for data driven downforce control of a vehicle. In an aspect of the present disclosure, the method for downforce control includes receiving a first requested downforce at a front axle of a vehicle. The vehicle includes a vehicle body and a first aerodynamic actuator coupled to the vehicle body, and the first aerodynamic actuator includes a first aerodynamic body movable relative to vehicle body. The method includes receiving a second requested downforce at the rear axle of the vehicle. The vehicle includes a second aerodynamic actuator coupled to the vehicle body, and the second aerodynamic actuator includes a second aerodynamic body movable relative to the vehicle body. The method includes using a model-based control to determine a first position of the first aerodynamic body relative to the vehicle body and a second position of the second aerodynamic body relative to the vehicle body based on the first requested downforce and the second requested downforce. The model-based control is based on a predetermined aerodynamic map. The method includes commanding the first aerodynamic actuator to move the first aerodynamic body to the first position. The method includes commanding the second aerodynamic actuator to move the second aerodynamic body to the second position.

In an aspect of the present disclosure, the model-based control is expressed with a model-based controller prediction model. The method includes updating the model-based controller prediction model.

In an aspect of the present disclosure, the method includes updating weight and biases of a neural network using the velocity of the vehicle, the ride height of the vehicle, the rear downforce at the rear axle of the vehicle, and the front downforce at the front axle of the vehicle.

In an aspect of the present disclosure, the method includes developing a linear time-variant (LTV) state space model from the neural network, and the LTV state space model and developing the model-based controller prediction model using the LTV state space model.

In an aspect of the present disclosure, the method includes using model predictive control (MPC) to determine the first position of the first aerodynamic body relative to the vehicle body and the second position of the second aerodynamic body relative to the vehicle body.

In an aspect of the present disclosure, the method includes using a linear-quadratic regulator (LQR) or model predictive control (MPC) to determine the first position of the first aerodynamic body relative to the vehicle body and the second position of the second aerodynamic body relative to the vehicle body.

The present application also describes a tangible, non-transitory, machine-readable medium, including machine-readable instructions. When executed by a processor, the machine-readable instructions cause the processor to receive the first requested downforce at the front axle of a vehicle. The vehicle includes a vehicle body and a first aerodynamic actuator coupled to the vehicle body, and the first aerodynamic actuator includes a first aerodynamic body movable relative to vehicle body. When executed by the processor, the machine-readable instructions cause the processor to receive a second requested downforce at a rear axle of the vehicle, wherein the vehicle includes a second aerodynamic actuator coupled to the vehicle body, and the second aerodynamic actuator includes a second aerodynamic body movable relative to the vehicle body. When executed by a processor, the machine-readable instructions cause the processor to use a model-based control to determine a first position of the first aerodynamic body relative to the vehicle body and a second position of the second aerodynamic body relative to the vehicle body based on the first requested downforce and the second requested downforce. When executed by a processor, the machine-readable instructions cause the processor to command the first aerodynamic actuator to move the first aerodynamic body to the first position. When executed by a processor, the machine-readable instructions cause the processor to command the second aerodynamic actuator to move the second aerodynamic body to the second position.

When executed by a processor, the machine-readable instructions cause the processor to receive data indicative of a velocity of the vehicle, a ride height of the vehicle, a rear downforce at the rear axle of the vehicle, and a front downforce at the front axle of the vehicle after the first aerodynamic body to the first position and the second aerodynamic body is in the second position. When executed by a processor, the machine-readable instructions cause the processor to update, in real-time, the model-based controller prediction model using the velocity of the vehicle, the ride height of the vehicle, the rear downforce at the rear axle of the vehicle, and the front downforce at the front axle of the vehicle.

When executed by a processor, the machine-readable instructions cause the processor to update weight and biases of a neural network using the velocity of the vehicle, the ride height of the vehicle, the rear downforce at the rear axle of the vehicle, and the front downforce at the front axle of the vehicle.

When executed by a processor, the machine-readable instructions cause the processor to develop a linear time-variant (LTV) state space model from the neural network, and the LTV state space model and develop the model-based controller prediction model using the LTV state space model.

When executed by a processor, the machine-readable instructions cause the processor to use model predictive control (MPC) to determine the first position of the first aerodynamic body relative to the vehicle body and the second position of the second aerodynamic body relative to the vehicle body.

When executed by a processor, the machine-readable instructions cause the processor to use a linear-quadratic regulator (LQR) to determine the first position of the first aerodynamic body relative to the vehicle body and the second position of the second aerodynamic body relative to the vehicle body.

The present disclosure also describes a vehicle. The vehicle includes a vehicle body, a front axle coupled to the vehicle body, a rear axle coupled to the vehicle body, a plurality of sensors disposed within the vehicle body, and a vehicle controller disposed within the vehicle body. The vehicle controller is in communication with the sensors. The vehicle controller is programmed to receive a first requested downforce at the front axle, wherein the vehicle includes the vehicle body and a first aerodynamic actuator coupled to the vehicle body, and the first aerodynamic actuator includes a first aerodynamic body movable relative to vehicle body. The vehicle controller is programmed to receive a second requested downforce at the rear axle of the vehicle, wherein the vehicle includes a second aerodynamic actuator coupled to the vehicle body, and the second aerodynamic actuator includes a second aerodynamic body movable relative to the vehicle body. The vehicle controller is programmed to use a model-based control to determine a first position of the first aerodynamic body relative to the vehicle body and a second position of the second aerodynamic body relative to the vehicle body based on the first requested downforce and the second requested downforce, and the model-based control is based on a predetermined aerodynamic map. The vehicle controller is programmed to command the first aerodynamic actuator to move the first aerodynamic body to the first position. The vehicle controller is programmed to command the second aerodynamic actuator to move the second aerodynamic body to the second position.

The vehicle controller is programmed to determine a velocity of the vehicle, a ride height of the vehicle, a rear downforce at the rear axle of the vehicle, and a front downforce at the front axle of the vehicle after the first aerodynamic body to the first position and the second aerodynamic body is in the second position, and the model-based control is represented by a model-based controller prediction model. The vehicle controller is programmed to update, in real-time, the model-based controller prediction model using the velocity of the vehicle, the ride height of the vehicle, the rear downforce at the rear axle of the vehicle, and the front downforce at the front axle of the vehicle.

The vehicle controller is programmed to update weight and biases of a neural network using the velocity of the vehicle, the ride height of the vehicle, the rear downforce at the rear axle of the vehicle, and the front downforce at the front axle of the vehicle.

The vehicle controller is programmed to develop a linear time-variant (LTV) state space model from the neural network and develop the model-based controller prediction model using the LTV state space model. The vehicle controller is programmed to use model predictive control (MPC) to determine the first position of the first aerodynamic body relative to the vehicle body and the second position of the second aerodynamic body relative to the vehicle body.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic side view of a vehicle including a system for data driven downforce control; and

FIG. 2 a flowchart of a method for data driven downforce control.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps.

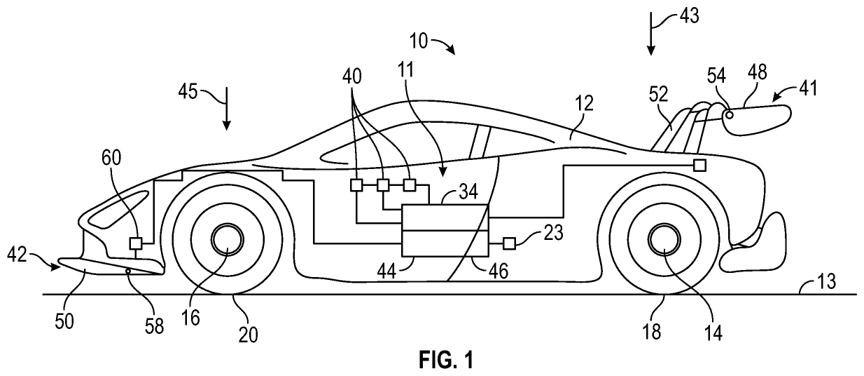

With reference to FIG. 1, a vehicle 10 includes (or is in communication with) a system 11 for data driven downforce control. While the system 11 is shown inside the vehicle 10, it is contemplated that the system 11 may be outside of the vehicle 10. As a non-limiting example, the system 11 may be in wireless communication with the vehicle 10. Although the vehicle 10 is shown as a sedan, it is envisioned that that vehicle 10 may be another type of vehicle, such as a pickup truck, a coupe, a sport utility vehicle (SUVs), a recreational vehicle (RVs), etc. The system 11 is developed for active downforce control that allows utilization of aero maps in state-space formulation for model-based control techniques. Further, the system 11 benefits from data driven techniques to update state-space model in real time based on the data obtained in real application. Updating the state-space models addresses the uncertainty of aero-maps and enables the vehicle motion control (VMC) to achieve superior performance in both near limit and limit handling conditions.

The vehicle 10 includes a vehicle controller 34 and one or more sensors 40 in communication with the vehicle controller 34. The sensors 40 collect information and generate sensor data indicative of the collected information. As non-limiting examples, the sensors 40 may include Global Navigation Satellite System (GNSS) transceivers or receivers, yaw rate sensors, ride height sensors, speed sensors, lidars, radars, ultrasonic sensors, and cameras, among others. The GNSS transceivers or receivers are configured to detect the location of the vehicle 10 in the globe. The speed sensors are configured to detect the speed of the vehicle 10. The yaw rate sensors are configured to determine the heading of the vehicle 10. The cameras may have a field of view large enough to capture images in front, in the rear, and in the sides of the vehicle 10. The ride height sensors are configured to measure the right height of the vehicle 10. The ultrasonic sensor may detect static and/or dynamic objects.

The vehicle controller 34 is programmed to receive sensor data from the sensors 40 and includes at least one processor 44 and a non-transitory computer readable storage device or media 46. The processor 44 may be a custom-made processor, a central processing unit (CPU), a graphics processing unit (GPU), an auxiliary processor among several processors associated with the vehicle controller 34, a semiconductor-based microprocessor (in the form of a microchip or chip set), a macroprocessor, a combination thereof, or generally a device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media of the vehicle controller 34 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 34 in controlling the vehicle 10.

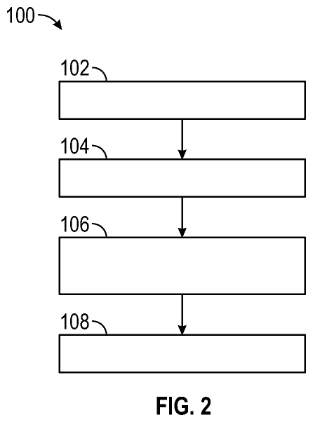

The instructions may include one or more separate programs, each of which comprises an ordered listing of executable instructions for implementing logical functions. The instructions, when executed by the processor 44, receive and process signals from the cameras, perform logic, calculations, methods and/or algorithms for automatically controlling the components of the vehicle 10, and generate control signals to the actuators (e.g., first aerodynamic actuator and/or second aerodynamic actuator 42) to automatically control the components of the vehicle 10 based on the logic, calculations, methods, and/or algorithms. Although a single vehicle controller 34 is shown in FIG. 1, the system 11 may include a plurality of controllers 34 that communicate over a suitable communication medium or a combination of communication mediums and that cooperate to process the sensor signals, perform logic, calculations, methods, and/or algorithms, and generate control signals to automatically control features of the system 11. In various embodiments, one or more instructions of the vehicle controller 34 are embodied in the system 11. The non-transitory computer readable storage device or media 46 includes machine-readable instructions (shown, for example, in FIG. 2), that when executed by the one or more processors, cause the processors 44 to execute the method 100 (FIG. 2).

The vehicle 10 includes a vehicle body 12, a first or rear axle 14, and a second or front axle 16. The first axle 14 and the second axle 16 are coupled to the vehicle body 12. Further, each of the first axle 14 and the second axle 16 are configured to rotate relative to the vehicle body 12. The vehicle 10 further includes one or more first or rear tires 18 coupled to the first axle 14 and one or more second or front tires 20 coupled to the second axle 16.

The vehicle 10 includes a first or rear aerodynamic actuator 41 and a second or front aerodynamic actuator 42 each in communication with the vehicle controller 34. The first aerodynamic actuator 41 includes the first aerodynamic body 48, and the second aerodynamic actuator 42 includes a second aerodynamic body 50. Each of the first aerodynamic body 48 and the second aerodynamic body 50 may be configured as a wing-shaped spoiler. In the present disclosure, the term “wing-shaped” is defined as having a shape of a wing, i.e., a fin having a shape of an airfoil defined by a streamlined cross-sectional shape producing lift for flight or propulsion through a fluid. The term “spoiler” means an aerodynamic device capable of disrupting air movement across the vehicle 10 while the vehicle 10 is in motion, thereby reducing drag and/or inducing an aerodynamic downforce on the vehicle 10. The term “downforce” means a force component that is perpendicular to the direction of relative motion of the vehicle 10, i.e., in the longitudinal direction, toward the road surface 13. For example, the spoiler can diffuse air by increasing the amount of turbulence flowing over it. The first aerodynamic actuator 41 is closer to the first axle 14 than to the second axle 16 to control a rear downforce 43 at or near the first axle 14. The second aerodynamic actuator 42 is closer to the second axle 16 than to the first axle 14 to control a front downforce 45 at or near the second axle 16. The rear downforce 43 and the front downforce 45 may be determined using sensor data from the sensors 40 (e.g., ride height sensors).

The first aerodynamic actuator 41 includes a support 52 directly coupled to the vehicle body 12 and one or more first pivots 54 (e.g., pivot pin, pivot mechanism, etc.) pivotally coupling the first aerodynamic body 48 to the vehicle body 12. Accordingly, the first aerodynamic body 48 is movable (e.g., pivotable) relative to the vehicle body 12. The first aerodynamic actuator 41 includes a first electric motor 56 (or another suitable machine) in communication with the vehicle controller 34 and coupled to the first aerodynamic body 48 through the first pivot 54. The vehicle controller 34 is therefore programmed to actuate the first electric motor 56 to move the first aerodynamic body 48 relative to the vehicle body 12.

The second aerodynamic actuator 42 is coupled to the vehicle body 12 and includes one or more second pivots 58 (e.g., pivot pin, pivot mechanism, etc.) pivotally coupling the second aerodynamic body 50 to the vehicle body 12. Accordingly, the second aerodynamic body 50 is movable (e.g., pivotable) relative to the vehicle body 12. The second aerodynamic actuator 42 includes a second electric motor 60 (or another suitable machine) in communication with the vehicle controller 34 and coupled to the second aerodynamic body 50 through the second pivot 58. The vehicle controller 34 is therefore programmed to actuate the second electric motor 60 to move the second aerodynamic body 50 relative to the vehicle body 12.

The vehicle 10 includes a user interface 23 in communication with the vehicle controller 34. The user interface 23 may be, for example, a touchscreen in the dashboard and may include, but is not limited to, an alarm, such as one or more speakers to provide an audible sound, haptic feedback in a vehicle seat or other object, one or more displays, one or more microphones, one or more lights, and/or other devices suitable to provide a notification. The user interface 23 is in electronic communication with the vehicle controller 34 and is configured to receive inputs from the hearing-impaired vehicle occupant 25 (e.g., a vehicle user or a vehicle passenger). For example, the user interface 23 may include a touch screen and/or buttons configured to receive inputs from the vehicle occupant. Accordingly, the vehicle controller 34 is configured to receive inputs from the vehicle occupant via the user interface 23 and to provide an output (e.g., audible, haptic, and/or visible notifications) to the vehicle occupant.

FIG. 2 is a flowchart of a method 100 for data driven downforce control. The method 100 begins at block 102. Block 102 entails offline training a model-based controller prediction model. In the present disclosure, the term “model-based controller prediction model” excludes a proportional-integral-derivative (PID) controller. At block 102, a neural network is developed from static data from a predetermined aerodynamic map. As non-limiting examples, the aerodynamic map may be derived by conducting a scale model wind tunnel test, a full-scale wind tunnel test, and/or a field test on a track or road. In other words, wind tunnel testing, field testing on a test track and/or another suitable test may be performed to generate the aerodynamic maps for the downforce actuators (e.g., the first aerodynamic actuator 41 and the second aerodynamic actuator 42). The aerodynamic maps are several 5-D tables that correlate the downforce and drag to air speed, rear and front ride heights, and the positions of the first aerodynamic actuator 41 and the second aerodynamic actuator 42 relative to the vehicle body 12. The system 11 is based on the neural network and is dynamic due to a feedback loop.

The structure of the neural network is developed for the model-based controller prediction model. The selection of the best neural network structure for the downforce actuator model is done through several iterations. The structure of the neural network is based on the complexity of the data and physical phenomena an appropriate neural network model. The model-based controller prediction model includes an aerodynamic actuator model and generates static downforce data from wind tunnel tests of the vehicle 10.

The selected neural network is then trained offline using simulation data using aero map model and also vehicle testing data (if available). The offline-trained neural network may be adapted online using measurements and estimations from production vehicle. To train the selected neural network, a plant model is developed using the aero maps for the aerodynamic actuators (e.g., first aerodynamic actuator and/or second aerodynamic actuator 42) with simple actuator dynamics.

Then, the trained neural network is validated with test data and through simulation or vehicle testing using different driving scenarios. Training data is simulated by sweeping the input signals from 0 to 100% with different frequencies. This data was partitioned into training, validation, and test data, which then is used to train the neural network. Run excessive simulations are run with sweeping inputs at different frequencies to generate enough offline training data. This assures at least high steady state accuracy of neural network model. Next, the neural network model is trained and tested using time history data gathered during simulation. Further offline training may be conducted to improve the model dynamics accuracy using data gathered during vehicle testing. Further real-time training may be performed using a real-time adaptive algorithm to improve both steady-state and dynamics accuracy of the model.

The neural network may be represented as non-linear state space model. To this end, a linear time-variant (LTV) state-space model is developed from the non-linear neural network by developing analytical correlation of partial derivatives of output with respect to the all the inputs and state. The LTV state-space model is then validated. The state-space model enables the usage of model-based control methods (e.g., Model Predictive Control (MPC), Linear Quadratic Regulator (LQR)). The non-linear state space representation of the neural network model may be the following equations:

$$x ( k + 1 ) = ℱ ( {X}_{k} , {U}_{k} , {D}_{m , k} ) = {W}_{31} σ ( {W}_{21} tan h ( {W}_{11} {D}_{m , k} + {W}_{12} {U}_{k} + {W}_{13} {X}_{k} + {B}_{1} ) + {B}_{2} ) + {B}_{3} \qquad Eq . 1$$

$${X}_{k + 1} : {}_{2 \times 1} , \qquad Eq . 2$$

$${X}_{k} : {2 \times 1}_{} , \qquad Eq . 3$$

$${W}_{31} : {2 \times 10}_{} , \qquad Eq . 4$$

$${W}_{21} : {10 \times 10}_{} , \qquad Eq . 5$$

$${W}_{11} : {10 \times 3}_{} , \qquad Eq . 6$$

$${W}_{12} : {10 \times 2}_{} , \qquad Eq . 7$$

$${W}_{13} : {10 \times 2}_{} , \qquad Eq . 8$$

$${B}_{1} : {10 \times 1}_{} , \qquad Eq . 9$$

$${B}_{2} : {10 \times 1}_{} , \qquad Eq . 10$$

$${B}_{3} : {}_{2 \times 1} , \qquad Eq . 11$$

$${D}_{m , k} : {}_{3 \times 1} , \qquad Eq . 12$$

$${U}_{k} : {}_{2 \times 1} , \qquad Eq . 13$$

where:
Uₖ are input vectors for the first aerodynamic actuator 41 and the second aerodynamic actuator 42;
Xₖ is the state vector for the rear downforce 43 and the front downforce 45 at current time step k;
k is the current time step;
D_{m,k} is the measured disturbance vectors at current time step k for the velocity the front ride height, and the rear ride height;
W₁₁ is the first layer weight matrix of the neural network for measured disturbances;
W₁₂ is the first layer weight matrix of the neural network for inputs;
W₁₃ is the first layer weight matrix of the neural network for previous states;
W₂₁ is the second layer weight matrix of the neural network;
W₃₁ is the third layer weight matrix of the neural network;
σ is the sigmoid function;
B₁ is the first layer bias vector of the neural network;
B₂ is the second layer bias vector of the neural network;
B₃ is the third layer bias vector of the neural network;
tanh is the tangent hyperbolic function; and
[symbol] _{m×x} is the m by n matrix with real values.

However, this non-liner state space model cannot be easily used for model-based control design unless it is linearized. To reduce computational cost of linearization, an analytical method is proposed to calculate linear state space matrices. To convert the above non-linear correlation to linear state space format, the partial derivatives of the output vector (i.e., Xₖ₊₁) to the input vector (i.e., Uₖ) and state vector (i.e., Xₖ) are calculated using the following equations:

$$Δ {X}_{k + 1} = A Δ {X}_{k} + B Δ {U}_{k} + {D}_{s} Δ {D}_{m , k} \to ( {X}_{k + 1} - {\hat{X}}_{k} ) = A ( {X}_{k} - {\hat{X}}_{k - 1} ) + B ( {U}_{k} - {\overline{U}}_{k - 1} ) + {D}_{s} ( {D}_{m , k} - {\hat{D}}_{m , k - 1} ) \to {X}_{k + 1} = {AX}_{k} + B {U}_{k} + \underbrace{( {D}_{s} ( {D}_{m , k} - {D}_{m , k - 1} ) + {\hat{X}}_{k} - A {\hat{X}}_{k - 1} - B {\hat{U}}_{k - 1} )}_{{D}_{x}} \qquad Eq . 14$$

$$A = \frac{\partial {X}_{k + 1}}{\partial {X}_{k}} {\vert}_{2 \times 2} = \text{} \frac{\partial ( {W}_{31} {M}_{1} )}{\partial {X}_{k}} = \frac{\partial ( {W}_{31} {M}_{1} )}{\partial {M}_{1}} {\vert}_{2 \times 10} \frac{\partial {M}_{1}}{\partial {M}_{2}} {\vert}_{10 \times 10} \frac{\partial {M}_{2}}{\partial {M}_{3}} {\vert}_{10 \times 10} \frac{\partial {M}_{3}}{\partial {X}_{k}} {\vert}_{10 \times 2} = {W}_{31} {M}_{4} {W}_{21} ( {I}_{10 \times 10} - {M}_{5} ) {W}_{13} \qquad Eq . 15$$

$$B = \frac{\partial {X}_{k + 1}}{\partial {U}_{k}} {\vert}_{2 \times 2} = {W}_{31} {M}_{4} {W}_{21} ( {I}_{10 \times 10} - {M}_{5} ) {W}_{12} \qquad Eq . 16$$

$${D}_{S} = \frac{\partial {X}_{k + 1}}{\partial {D}_{m , k}} {\vert}_{2 \times 3} = {W}_{31} {M}_{4} {W}_{21} ( {I}_{10 \times 10} - {M}_{5} ) {W}_{11} \qquad Eq . 17$$

$${M}_{1}^{10 \times 1} = σ ( {M}_{2} ) \qquad Eq . 18$$

$${M}_{2}^{10 \times 1} = {W}_{21} tan h ( {M}_{3} ) + {B}_{2} \qquad Eq . 19$$

$${M}_{3}^{10 \times 1} = {W}_{11} {D}_{m , k} + {W}_{12} {\hat{U}}_{k} + {W}_{13} {\hat{X}}_{k} + {B}_{1} \qquad Eq . 20$$

$${M}_{4}^{10 \times 10} = diag ( σ ( {M}_{2} ) ) - diag ( {σ}^{2} ( {M}_{2} ) ) \qquad Eq . 21$$

$${M}_{5}^{10 \times 10} = diag ( tan {h}^{2} ( {M}_{3} ) ) \qquad Eq . 22$$

$$tan h ( x ) = 2 / ( 1 + exp ( - 2 x ) ) - 1 \qquad Eq . 23$$

$$σ ( x ) = 1 / ( 1 + exp ( - x ) ) \qquad Eq . 24$$

where:
Xₖ is the state vector for the rear downforce 43 and the front downforce 45 at current time step k;
Xₖ₊₁ is the state vector for the rear downforce 43 and the front downforce 45 at next time step k+1
k is the current time step;
\hat{X}ₖ is the estimated or measured X at time step k;
Ûₖ₋₁ is the estimated or measured U at previous time step k−1;
D_{m,k-1} is the measured or estimated disturbances at time step k−1 (previous time step);
A is the system matrix;
B is the input matrix;
C is the output matrix;
exp is the exponential function;
diag(x) is the diagonal matrix with diagonal elements corresponding to the elements of vector x;
D_{m,k} is the measured disturbance vectors at current time step k for the velocity the front ride height, and the rear ride height;
Dₛ is the matrix representing the left over in the delta state equation (ΔXₖ);
Dₓ is the Matrix representing the left over in state equation (Xₖ);
Uₖ are input vectors for the first aerodynamic actuator 41 and the second aerodynamic actuator 42;
Xₖ is the state vector for the rear downforce 43 and the front downforce 45 at current time step k;
k is the current time step;
D_{m,k} is the measured disturbance vectors at current time step k for the velocity the front ride height, and the rear ride height;
W₁₁ is the first layer weight matrix of the neural network for measured disturbances;
W₁₂ is the first layer weight matrix of the neural network for inputs;
W₁₃ is the first layer weight matrix of the neural network for previous states;
W₂₁ is the second layer weight matrix of the neural network;
W₃₁ is the third layer weight matrix of the neural network;
σ is the sigmoid function;
B₁ is the first layer bias vector of the neural network;
B₂ is the second layer bias vector of the neural network;
B₃ is the third layer bias vector of the neural network; and
tanh is the tangent hyperbolic function.

Then, a real-time training algorithm is developed for online adaptation of neural network weights and biases. A sensitivity analysis is performed to select the most significant weights and bias for online adaptation and a lost function is defined. To realize this online adaptation, an analytical method is proposed to calculate the Jacobian and gradient matrices of prediction error with respect to all weights and biases. An analytical Jacobian matrices for partial derivatives of lost function of the neural network with respect to all the weights and biases are developed. To improve the neural network model accuracy, the weights and biases may be updated using the measured or estimated signals on the vehicle. The gradient descent method is used to update the selected weight and biases. The Newton Raphson method is used to update the gains and weights using the calculated Jacobians and Gradients matrices. The state space model matrices used for model predictive control is updated every execution time using inputs from the vehicle 10. In other words, the online adaptation algorithm also continuously updates the NN weights and biases which again used in calculation of the state space model matrices. The partial derivatives of error cost function with respect to weights and biases may be calculated using the following equation:

$$\frac{\partial E}{\partial {W}_{i j}} \qquad Eq . 25$$

$$\frac{\partial E}{\partial {B}_{i}} \qquad Eq . 26$$

where:
Bᵢ is the bias vector of the layer i of the neural network;
Wᵢⱼ is the weight matrix of the layer i of the neural network for state j; and
E is the summed squared error between neural network prediction and actual measurement or estimation for front and rear downforces.

The following equations may be used to update the weights and biases of the neural network:

$${W}_{ij} = {W}_{ij} - λ \frac{\partial E}{\partial {W}_{ij}} \qquad Eq . 27$$

$${B}_{i} = {B}_{i} - \frac{\partial E}{\partial {B}_{i}} \qquad Eq . 28$$

where:
Bᵢ is the bias vector of the layer i of the neural network;
Wᵢⱼ is the weight matrix of the layer i of the neural network for state j; and
E is the summed squared error) between neural network prediction and actual measurement or estimation for front and rear downforces.

The Jacobians and Gradients matrices are developed using auto differentiation. The lost function is defined by the following equation:

$$E = {( Y - {Y}_{d} )}^{T} ( Y - {Y}_{d} ) \qquad Eq . 29$$

where:
E is the summed squared error between neural network prediction and actual measurement or estimation for front and rear downforces;
Y is the predicted neural network downforce vector; and
Y_{d} is the measured or estimated downforce vector.

The Jacobian matrices are calculated using the following equations:

$$\frac{\partial E}{\partial {W}_{11}} = \text{} 2 \text{} {( Y - {Y}_{d} )}^{T} {\vert}_{1 \times 2} \text{} \frac{\partial Y}{\partial {W}_{11}} {\vert}_{2 \times 10 \times 3} = \text{} 2 \text{} {( Y - {Y}_{d} )}^{T} {\vert}_{1 \times 2} \text{} ( {W}_{31} {M}_{4} {W}_{21} ( {I}_{10 \times 10} - \text{} {M}_{5} ) ) {\vert}_{2 \times 10} \frac{\partial ( {W}_{11} {D}_{m , k} )}{\partial {W}_{11}} {\vert}_{10 \times 30} \qquad Eq . 30$$

$$\frac{\partial E}{\partial {W}_{12}} = 2 {( Y - {Y}_{d} )}^{T} {\vert}_{1 \times 2} ( {W}_{31} {M}_{4} {W}_{21} ( {I}_{10 \times 10} - {M}_{5} ) ) {\vert}_{2 \times 10} \frac{\partial ( {W}_{12} {U}_{k} )}{\partial {W}_{12}} {\vert}_{10 \times 20} \qquad Eq . 31$$

$$\frac{\partial E}{\partial {W}_{13}} = 2 {( Y - {Y}_{d} )}^{T} {\vert}_{1 \times 2} ( {W}_{31} {M}_{4} {W}_{21} ( {I}_{10 \times 10} - {M}_{5} ) ) {\vert}_{2 \times 10} \frac{\partial ( {W}_{13} {X}_{k} )}{\partial {W}_{13}} {\vert}_{10 \times 20} \qquad Eq . 32$$

$$\frac{\partial E}{\partial {W}_{21}} = 2 {( Y - {Y}_{d} )}^{T} {\vert}_{1 \times 2} ( {W}_{31} {M}_{4} ) {\vert}_{2 \times 10} \frac{\partial ( {W}_{21} tanh ( {M}_{3} ) )}{\partial {W}_{21}} {\vert}_{10 \times 100} \qquad Eq . 33$$

$$\frac{\partial E}{\partial {W}_{31}} = 2 {( Y - {Y}_{d} )}^{T} {\vert}_{1 \times 2} \frac{\partial ( {W}_{31} {M}_{1} )}{\partial {W}_{31}} {\vert}_{2 \times 20} \qquad Eq . 34$$

$$\frac{\partial E}{\partial {B}_{1}} = 2 {( Y - {Y}_{d} )}^{T} {\vert}_{1 \times 2} ( {W}_{31} {M}_{4} {W}_{21} ( {I}_{10 \times 10} - {M}_{5} ) ) {\vert}_{2 \times 10} \qquad Eq . 35$$

$$\frac{\partial E}{\partial {B}_{2}} = 2 {( Y - {Y}_{d} )}^{T} {\vert}_{1 \times 2} ( {W}_{31} {M}_{4} ) {\vert}_{2 \times 10} \qquad Eq . 36$$

$$\frac{\partial E}{\partial {B}_{3}} = 2 {( Y - {Y}_{d} )}^{T} {\vert}_{1 \times 2} {I}_{2 \times 2} \qquad Eq . 37$$

$$Eq . 38$$

$$\frac{\partial ( {W}_{11} {D}_{m} )}{\partial {W}_{11}} {\vert}_{10 \times 30} = {[ \begin{matrix}D {m}_{l} & D {m}_{2} & D {m}_{3} & 0 & 0 & 0 & … & 0 & 0 & 0 \\ 0 & 0 & 0 & {Dm}_{1} & D {m}_{2} & D {m}_{3} & … & 0 & 0 & 0 \\ ⋮ & ⋮ & ⋮ & ⋮ & ⋮ & ⋮ & ⋱ & 0 & 0 & 0 \\ 0 & 0 & 0 & 0 & 0 & 0 & … & {Dm}_{1} & {Dm}_{2} & {Dm}_{3}\end{matrix} ]}_{10 \times 30}$$

$$Eq . 39$$

$$\frac{\partial ( {W}_{12} {U}_{k} )}{\partial {W}_{12}} {\vert}_{10 \times 30} = {[ \text{} \begin{matrix}{U}_{k} ( 1 ) & {U}_{k} ( 2 ) & 0 & 0 & 0 & 0 & … & 0 & 0 \\ 0 & 0 & {U}_{k} ( 1 ) & {U}_{k} ( 2 ) & 0 & 0 & … & 0 & 0 \\ ⋮ & ⋮ & ⋮ & ⋮ & ⋮ & ⋮ & ⋱ & 0 & 0 \\ 0 & 0 & 0 & 0 & 0 & 0 & … & {U}_{k} ( 1 ) & {U}_{k} ( 2 )\end{matrix} ]}_{10 \times 20}$$

$$Eq . 40$$

$$\frac{\partial ( {W}_{13} {X}_{k} )}{\partial {W}_{13}} {\vert}_{10 \times 30} = {[ \begin{matrix}{X}_{k} ( 1 ) & {X}_{k} ( 2 ) & 0 & 0 & 0 & 0 & … & 0 & 0 \\ 0 & 0 & {X}_{k} ( 1 ) & {X}_{k} ( 2 ) & 0 & 0 & … & 0 & 0 \\ ⋮ & ⋮ & ⋮ & ⋮ & ⋮ & ⋮ & ⋱ & 0 & 0 \\ 0 & 0 & 0 & 0 & 0 & 0 & … & {X}_{k} ( 1 ) & {X}_{k} ( 2 )\end{matrix} ]}_{10 \times 20}$$

$$Eq . 41$$

$$\frac{\partial ( {W}_{21} tan h ( {M}_{3} ) )}{\partial {W}_{21}} {\vert}_{10 \times 100} = {[ \text{} \begin{matrix}tan h ( {M}_{3} ) ( 1 ) & … & tan h ( {M}_{3} ) ( 10 ) & 0 & … & 0 & … & 0 & … & 0 \\ 0 & … & 0 & tan h ( {M}_{3} ) ( 1 ) & … & tan h ( {M}_{3} ( 10 ) & … & 0 & … & 0 \\ ⋮ & ⋮ & ⋮ & ⋮ & ⋮ & ⋮ & ⋱ & ⋮ & ⋮ & ⋮ \\ 0 & … & 0 & 0 & … & 0 & … & tan h ( {M}_{3} ( 1 ) & … & tan h ( {M}_{3} ) ( 10 )\end{matrix} ]}_{10 \times 100}$$

$$\frac{\partial ( {W}_{31} {M}_{1} )}{\partial {W}_{31}} {\vert}_{2 \times 20} = {[ \begin{matrix}{M}_{1} ( 1 ) & … & {M}_{1} ( 10 ) & 0 & … & 0 \\ 0 & … & 0 & {M}_{1} ( 1 ) & … & {M}_{1} ( 10 )\end{matrix} ]}_{10 \times 100} \qquad Eq . 42$$

where:
Y is the predicted neural network downforce vector; and
Y_{d} is the measured or estimated downforce vector.
W₁₁ is the first layer weight matrix of the neural network for measured disturbances;
W₁₂ is the first layer weight matrix of the neural network for inputs;
W₁₃ is the first layer weight matrix of the neural network for previous states;
W₂₁ is the second layer weight matrix of the neural network; and
W₃₁ is the third layer weight matrix of the neural network.

Once offline training is conducted at block 102, the method 100 continues to block 104. At block 104, the vehicle controller 34 receives the desired downforce at first axle 14 (i.e., rear axle) and the second axle 16 (i.e., front axle) (i.e., the first requested downforce at the front axle 16 of the vehicle 10 and a second requested downforce at the rear axle 14 of the vehicle 10). The desired downforce (i.e., the rear downforce 43 and the front downforce 45) may be based on the inputs from the vehicle occupant or sensor data. The sensor data, for example, may include slip conditions based on inputs from wheel sensors. Next, the method 100 continues to block 106.

At block 106, the vehicle controller 34 uses the model-based control (as developed using the equations above) to determine the positions of the first aerodynamic actuator 41 and the second aerodynamic actuator 42 to achieve the first requested downforce at the front axle 16 of the vehicle 10 the a second requested downforce at the rear axle 14 of the vehicle 10. At block 106, the model-based control method used may be, for example, Model Predictive Control (MPC) or Linear Quadratic Regulator (LQR). Further, at block 106, the vehicle controller 34 commands the first aerodynamic actuator 41 and the second aerodynamic actuator 42 to the previously determined positions. Specifically, the vehicle controller 34 commands the first aerodynamic actuator 41 to move the first aerodynamic body 48 to the previously determined position relative to the vehicle body 12 Further, the vehicle controller 34 commands the second aerodynamic actuator 42 to move the second aerodynamic body 50 to the previously determined position relative to the vehicle body 12. Then, the method 100 proceeds to block 108.

At block 108, the vehicle controller 34 updates the model-based control model using the equations discussed above. Specifically, the vehicle controller 34, using sensor data, determines a longitudinal velocity of the vehicle 10, the ride height of the vehicle 10 at the first axle 14 and the of the vehicle 10, the rear downforce 43 at the rear axle 14 of the vehicle 10, and the front downforce 45 at the front axle 16 of the vehicle 10 after the first aerodynamic body 48 is in the first position and the second aerodynamic body 50 is in the second position. Then, the vehicle controller 34 updates, in real-time, the model-based controller prediction model using longitudinal velocity of the vehicle 10, the ride height of the vehicle 10 at the first axle 14 and the of the vehicle 10, the rear downforce 43 at the rear axle 14 of the vehicle 10, and the front downforce 45 at the front axle 16 of the vehicle 10.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the presently disclosed system and method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

Embodiments of the present disclosure are described herein. It is to be understood, however, that the disclosed embodiments are merely examples and other embodiments can take various and alternative forms. The figures are not necessarily to scale; some features could be exaggerated or minimized to display details of particular components. Therefore, specific structural and functional details disclosed herein are not to be interpreted as limiting, but merely as a representative basis for teaching one skilled in the art to variously employ the presently disclosed system and method. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure may be described herein terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for downforce control, comprising:
receiving a first requested downforce at a front axle of a vehicle, wherein the vehicle includes a vehicle body and a first aerodynamic actuator coupled to the vehicle body, and the first aerodynamic actuator includes a first aerodynamic body movable relative to vehicle body;
receiving a second requested downforce at a rear axle of the vehicle, wherein the vehicle includes a second aerodynamic actuator coupled to the vehicle body, and the second aerodynamic actuator includes a second aerodynamic body movable relative to the vehicle body;
using a model-based controller prediction model to determine a first position of the first aerodynamic body relative to the vehicle body and a second position of the second aerodynamic body relative to the vehicle body based on the first requested downforce and the second requested downforce, and the model-based controller prediction model is based on a predetermined aerodynamic map;
commanding the first aerodynamic actuator to move the first aerodynamic body to the first position; and
commanding the second aerodynamic actuator to move the second aerodynamic body to the second position.

2. The method of claim 1, wherein the method further comprises:
receiving data indicative of a velocity of the vehicle, a ride height of the vehicle, a rear downforce at the rear axle of the vehicle, and a front downforce at the front axle of the vehicle after the first aerodynamic body to the first position and the second aerodynamic body is in the second position.

3. The method of claim 2, wherein the method further comprises updating, in real-time, the model-based controller prediction model using the velocity of the vehicle, the ride height of the vehicle, the rear downforce at the rear axle of the vehicle, and the front downforce at the front axle of the vehicle.

4. The method of claim 3, wherein updating the model-based controller prediction model includes updating weight and biases of a neural network using the velocity of the vehicle, the ride height of the vehicle, the rear downforce at the rear axle of the vehicle, and the front downforce at the front axle of the vehicle.

5. The method of claim 4, further comprising:
developing a linear time-variant (LTV) state space model from the neural network, and the LTV state space model; and
developing the model-based controller prediction model using the LTV state space model.

6. The method of claim 5, wherein using the model-based controller prediction model includes using model predictive control (MPC) to determine the first position of the first aerodynamic body relative to the vehicle body and the second position of the second aerodynamic body relative to the vehicle body.

7. The method of claim 6, wherein using the model-based controller prediction model includes using a linear-quadratic regulator (LQR) to determine the first position of the first aerodynamic body relative to the vehicle body and the second position of the second aerodynamic body relative to the vehicle body.

8. A tangible, non-transitory, machine-readable medium, comprising machine-readable instructions, that when executed by a processor, cause the processor to:
receive a first requested downforce at a front axle of a vehicle, wherein the vehicle includes a vehicle body and a first aerodynamic actuator coupled to the vehicle body, and the first aerodynamic actuator includes a first aerodynamic body movable relative to vehicle body;
receive a second requested downforce at a rear axle of the vehicle, wherein the vehicle includes a second aerodynamic actuator coupled to the vehicle body, and the second aerodynamic actuator includes a second aerodynamic body movable relative to the vehicle body;
use a model-based control to determine a first position of the first aerodynamic body relative to the vehicle body and a second position of the second aerodynamic body relative to the vehicle body based on the first requested downforce and the second requested downforce;
command the first aerodynamic actuator to move the first aerodynamic body to the first position; and
command the second aerodynamic actuator to move the second aerodynamic body to the second position.

9. The tangible, non-transitory, machine-readable medium of claim 8, wherein the tangible, non-transitory, machine-readable medium further comprising machine-readable instructions, that when executed by the processor, causes the processor to:
receive data indicative of a velocity of the vehicle, a ride height of the vehicle, a rear downforce at the rear axle of the vehicle, and a front downforce at the front axle of the vehicle after the first aerodynamic body to the first position and the second aerodynamic body is in the second position, and the model-based control is represented by a model-based controller prediction model.

10. The tangible, non-transitory, machine-readable medium of claim 9, wherein the tangible, non-transitory, machine-readable medium further comprising machine-readable instructions, that when executed by the processor, causes the processor to:
update, in real-time, the model-based controller prediction model using the velocity of the vehicle, the ride height of the vehicle, the rear downforce at the rear axle of the vehicle, and the front downforce at the front axle of the vehicle.

11. The tangible, non-transitory, machine-readable medium of claim 10, wherein the tangible, non-transitory, machine-readable medium further comprising machine-readable instructions, that when executed by the processor, causes the processor to:
update weight and biases of a neural network using the velocity of the vehicle, the ride height of the vehicle, the rear downforce at the rear axle of the vehicle, and the front downforce at the front axle of the vehicle.

12. The tangible, non-transitory, machine-readable medium of claim 11, wherein the tangible, non-transitory, machine-readable medium further comprising machine-readable instructions, that when executed by the processor, causes the processor to:
develop a linear time-variant (LTV) state space model from the neural network, and the LTV state space model; and
develop the model-based controller prediction model using the LTV state space model.

13. The tangible, non-transitory, machine-readable medium of claim 12, wherein the tangible, non-transitory, machine-readable medium further comprising machine-readable instructions, that when executed by the processor, causes the processor to:
use model predictive control (MPC) to determine the first position of the first aerodynamic body relative to the vehicle body and the second position of the second aerodynamic body relative to the vehicle body.

14. The tangible, non-transitory, machine-readable medium of claim 13, wherein the tangible, non-transitory, machine-readable medium further comprising machine-readable instructions, that when executed by the processor, causes the processor to:
use a linear-quadratic regulator (LQR) to determine the first position of the first aerodynamic body relative to the vehicle body and the second position of the second aerodynamic body relative to the vehicle body.

15. A vehicle, comprising:
a vehicle body;
a front axle coupled to the vehicle body;
a rear axle coupled to the vehicle body;
a plurality of sensors disposed within the vehicle body;
a vehicle controller disposed within the vehicle body, wherein the vehicle controller is in communication with the plurality of sensors, and the vehicle controller is programmed to:
receive a first requested downforce at the front axle, wherein the vehicle includes the vehicle body and a first aerodynamic actuator coupled to the vehicle body, and the first aerodynamic actuator includes a first aerodynamic body movable relative to vehicle body;
receive a second requested downforce at the rear axle of the vehicle, wherein the vehicle includes a second aerodynamic actuator coupled to the vehicle body, and the second aerodynamic actuator includes a second aerodynamic body movable relative to the vehicle body;
use a model-based control to determine a first position of the first aerodynamic body relative to the vehicle body and a second position of the second aerodynamic body relative to the vehicle body based on the first requested downforce and the second requested downforce, and the model-based control is based on a predetermined aerodynamic map;
command the first aerodynamic actuator to move the first aerodynamic body to the first position; and
command the second aerodynamic actuator to move the second aerodynamic body to the second position.

16. The vehicle of claim 15, wherein the vehicle controller is programmed to:
determine a velocity of the vehicle, a ride height of the vehicle, a rear downforce at the rear axle of the vehicle, and a front downforce at the front axle of the vehicle after the first aerodynamic body to the first position and the second aerodynamic body is in the second position, and the model-based control is represented by a model-based controller prediction model.

17. The vehicle of claim 16, wherein the vehicle controller is programmed to update, in real-time, the model-based controller prediction model using the velocity of the vehicle, the ride height of the vehicle, the rear downforce at the rear axle of the vehicle, and the front downforce at the front axle of the vehicle.

18. The vehicle of claim 17, wherein the vehicle controller is programmed to:
update weight and biases of a neural network using the velocity of the vehicle, the ride height of the vehicle, the rear downforce at the rear axle of the vehicle, and the front downforce at the front axle of the vehicle.

19. The vehicle of claim 18, wherein the vehicle controller is programmed to:
develop a linear time-variant (LTV) state space model from the neural network, and the LTV state space model; and
develop the model-based controller prediction model using the LTV state space model.

20. The vehicle of claim 19, wherein the vehicle controller is programmed to:
use model predictive control (MPC) to determine the first position of the first aerodynamic body relative to the vehicle body and the second position of the second aerodynamic body relative to the vehicle body.
